(19) United States
(12) Patent Application Publication
(10) Pub. No.: US 2019/0013616 A1
(43) Pub. Date: Jan. 10, 2019

(54) ELECTRICAL CONNECTOR FOR NETWORK CABLES

(71) Applicant: Din Yi Industrial Co., Ltd., New Taipei City (TW)

(72) Inventor: Ching Kun HUANG, New Taipei City (TW)

(73) Assignee: Din Yi Industrial Co., Ltd., New Taipei City (TW)

(21) Appl. No.: 15/641,700

(22) Filed: Jul. 5, 2017

(51) Int. Cl. H01R 13/52; H01R 24/64

(52) U.S. Cl. CPC H01R 13/5202; H01R 2107/00; H01R 24/64

(57) ABSTRACT

An electrical connector for network cables includes a shell internally defining a first and a second insertion space communicable with each other via passages; conducting elements respectively including a conducting section seated in one passage and a first and a second contacting section extended from two opposite ends of the conducting section to extend into the first and the second insertion space, respectively; and a first and a second locating member mounted in the first and the second insertion space, respectively. The first and second locating members include a plurality of first and second guide slots, respectively, for receiving a partial length of the first and second contacting sections, respectively, such that the first and second contacting sections being pushed by inserted network cables are limited to move vertically in the first and second guide slots and accordingly firmly hold front ends of the network cables in the electrical connector.

### FIELD OF THE INVENTION

The present invention relates to an electrical connector for network cables, and more particularly to an electrical connector that is internally provided with locating members to ensure firm and stable electrical connection and holding of a plurality of network cables to the electrical connector.

### BACKGROUND OF THE INVENTION

In the new era of communication, consumers always pursue high-speed digital transmission of electronic information. Therefore, various types of electronic connectors to be connected to the cable ends of various electronic products play a critical role in the connection to between different electronic products via cables.

Thanks to the high digital transmission rate available over networks, many advanced digital products can have continuously improved functions to transmit multi-media audio/video signals that satisfy people's visual requirements for high quality images. For this purpose, the working frequency for signal transmission becomes higher and higher, and the electronic connectors for transferring digital signals now encounter the challenge of making changes in design more quickly.

The main function of an electronic connector is to electrically connect two or more electronic products to one another at the ends of their cables. However, the electronic products may have the same or different structures at the ends of their cables, which will have an influence on the stable connection of a plurality of cable ends via the electronic connectors.

### SUMMARY OF THE INVENTION

A primary object of the present invention is to provide an electrical connector with internal locating members, which help conducting elements in the electrical connector to exert an enhanced clamping force on a plurality of network cables inserted into the electrical connector.

Another object of the present invention is to provide an electrical connector with internal locating members, which have differently oriented surfaces for simultaneously pressing against an internal stopper and inner wall surfaces of a shell of the electrical connector, so as to ensure stable holding of the internal stopper and other elements to the shell of the electrical connector.

To achieve the above and other objects, the electrical connector provided according to the present invention for electrically connecting to network cables includes a shell, a plurality of conducting elements, a first locating member and a second locating member. The shell internally defines a first insertion space and a second insertion space, which are communicable with each other via a plurality of passages formed between them.

The conducting elements are correspondingly mounted in the passages. Each of the conducting elements includes a conducting section seated in one of the passages and a first and a second contacting section extended from two opposite ends of the conducting section. The first contacting sections are extended into the first insertion space while the second contacting sections are extended into the second insertion space.

The first locating member is mounted in the first insertion space and includes a plurality of first guide slots. The first guide slots respectively receive a partial length of one of the first contacting sections, such that the first contacting sections being pushed are limited to only a vertical movement in the first guide slots.

The second locating member is mounted in the second insertion space and includes a plurality of second guide slots. The second guide slots respectively receive a partial length of one of the second contacting sections, such that the second contacting sections being pushed are limited to only a vertical movement in the second guide slots.

The shell includes an outer shell portion and an internal stopper. The outer shell portion internally defines a through hole having two open ends formed on two opposite end surfaces of the outer shell portion. The internal stopper is disposed in the through hole and includes a pressing portion and a separating portion. The pressing portion is fitted and held in place in the through hole. The separating portion separates the through hole into the first insertion space and the second insertion space. The passages are parallelly arranged in the pressing portion to space from one another.

The outer shell portion includes a front shell and a rear shell. The front shell includes a first tubular section and a first radially protruded annular section formed at an end of the first tubular section. The first radially protruded annular section is formed on one side with an annular wall portion, which is extended in a cable insertion direction. And, the annular wall portion has a first outer diameter. The rear shell includes a second tubular section and a second radially protruded annular section formed at an end of the second tubular section to face toward the first radially protruded annular section. And, the second radially protruded annular section has a second outer diameter that is smaller than the first outer diameter. When the annular wall portion of the front shell is riveted, the first outer diameter of the annular wall portion is reduced to tightly press against the second outer diameter of the second radially protruded annular section, bringing the front shell and the rear shell to firmly connect to each other end to end.

In a preferred operable embodiment of the present invention, the front shell and the rear shell are made of different materials.

The first tubular section and the second tubular section are correspondingly provided on their contact surfaces with at least one retaining slot and at least one protruded block, respectively. The retaining slot is sunken from the contact surface of the first tubular section in the cable insertion direction, and the protruded block is projected from the contact surface of the second tubular section in the cable insertion direction. When the protruded blocks are engaged with the retaining slots, the front shell and the rear shell are prevented from rotating relative to each other.

A part of an inner wall surface of the outer shell portion that is in contact with the pressing portion and the separating portion of the internal stopper is formed into a recess, and a waterproof glue is applied in the recess to ensure a watertight and rust-resistant sealing between the outer shell portion and the internal stopper.

The first locating member is provided on a surface adjacent to the internal stopper with at least one first pressing section, and the second locating member is provided on a surface adjacent to the internal stopper with at least one second pressing section and at least one third pressing section. The at least one third pressing section is located corresponding to the at least one protruded block on the second tubular section of the rear shell and also pushes against the at least one retaining slot on the first tubular section of the front shell.

In summary, the electrical connector of the present invention is characterized in the first and the second locating member, which are engaged with the first and the second contacting sections, respectively, to indirectly help the conducting elements to stably exert a clamping force on the ends of the network cables inserted into the electrical connector, so that the network cables are firmly pressed against the inner wall surfaces of the shell and the possibility of easy sliding or moving of the cable ends out of the electrical connector is largely reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of an electrical connector for network cables according to a preferred embodiment of the present invention;

FIG. 2 is another assembled perspective view of the electrical connector for network cables according to the preferred embodiment of the present invention, viewed from a different angle;

FIG. 3 is a longitudinal sectional view of the electrical connector for network cables shown in FIG. 1;

FIG. 4 is an exploded view of the electrical connector for network cables shown in FIG. 1;

FIG. 5 is an exploded perspective view showing an internal stopper, a plurality of conducting elements and first and second locating members of the electrical connector for network cables according to the present invention; and

FIG. 6 is a cutaway view of the electrical connector for network cables shown in FIG. 1.

### DETAILED DESCRIPTION OF THE PREFERRED EMBODIMENTS

The present invention will now be described with a preferred embodiment thereof and by referring to the accompanying drawings.

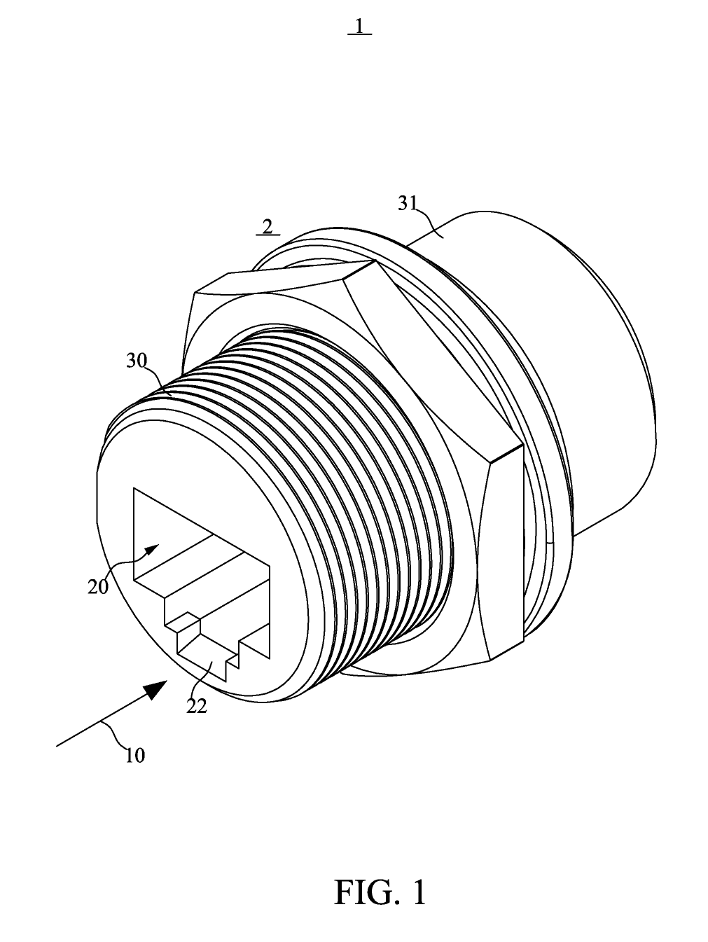

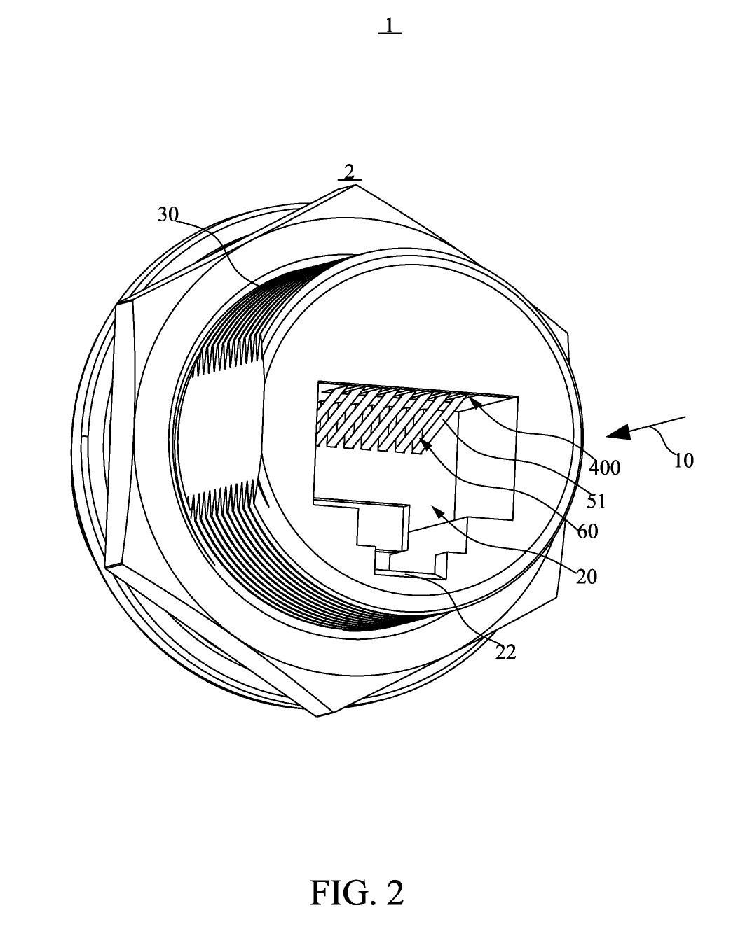

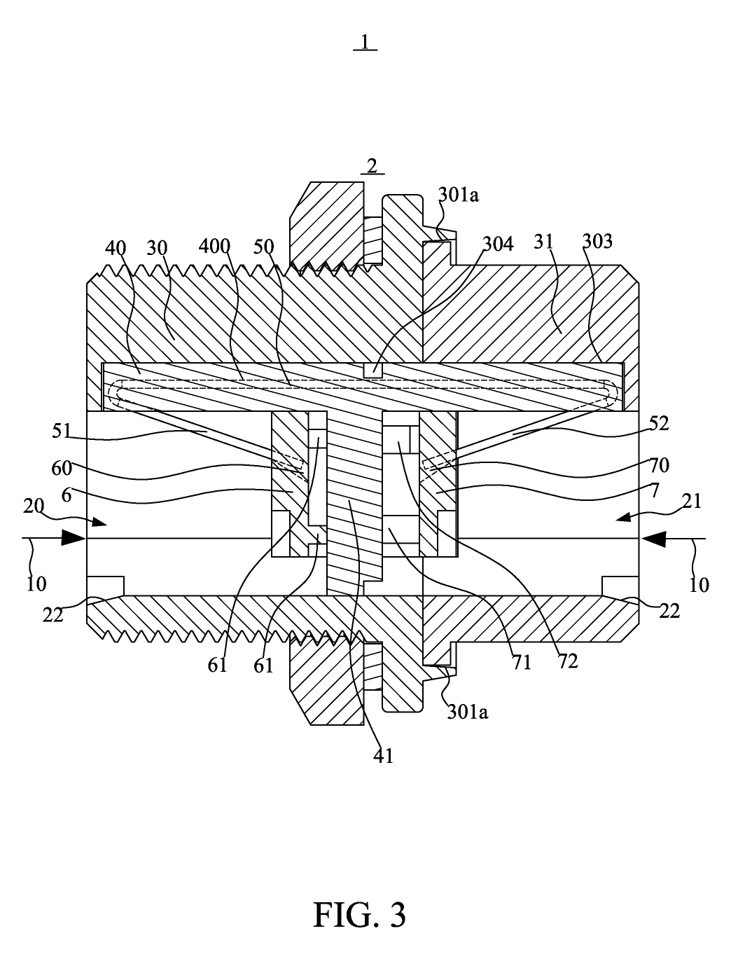

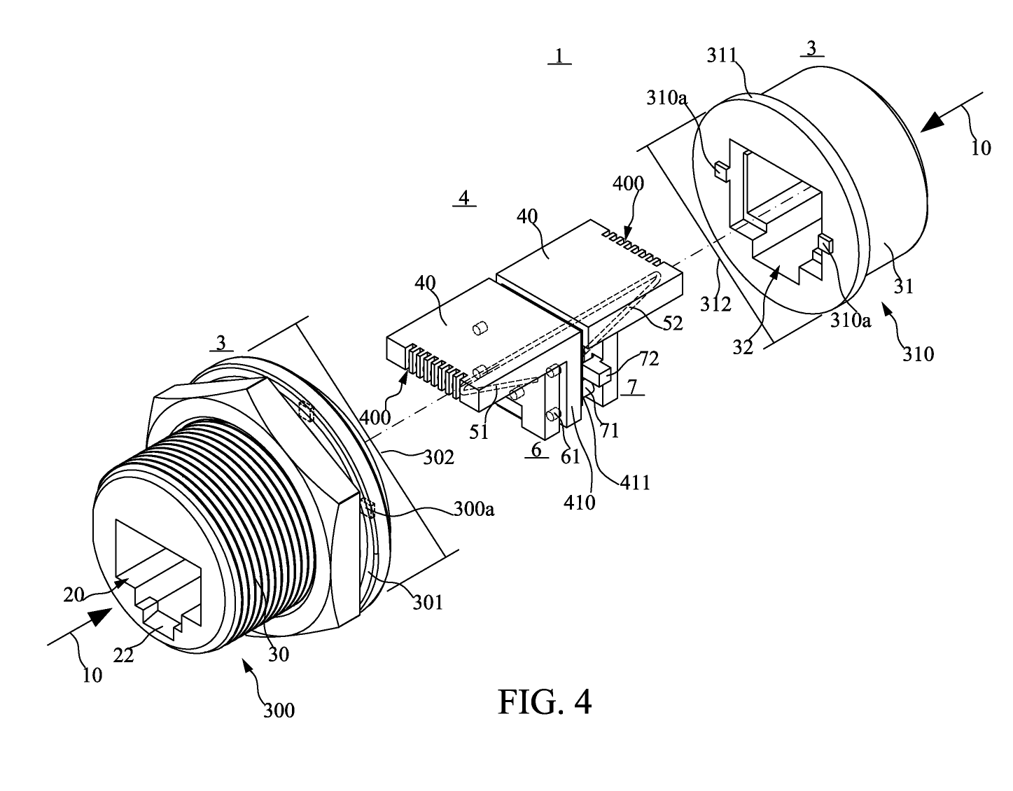

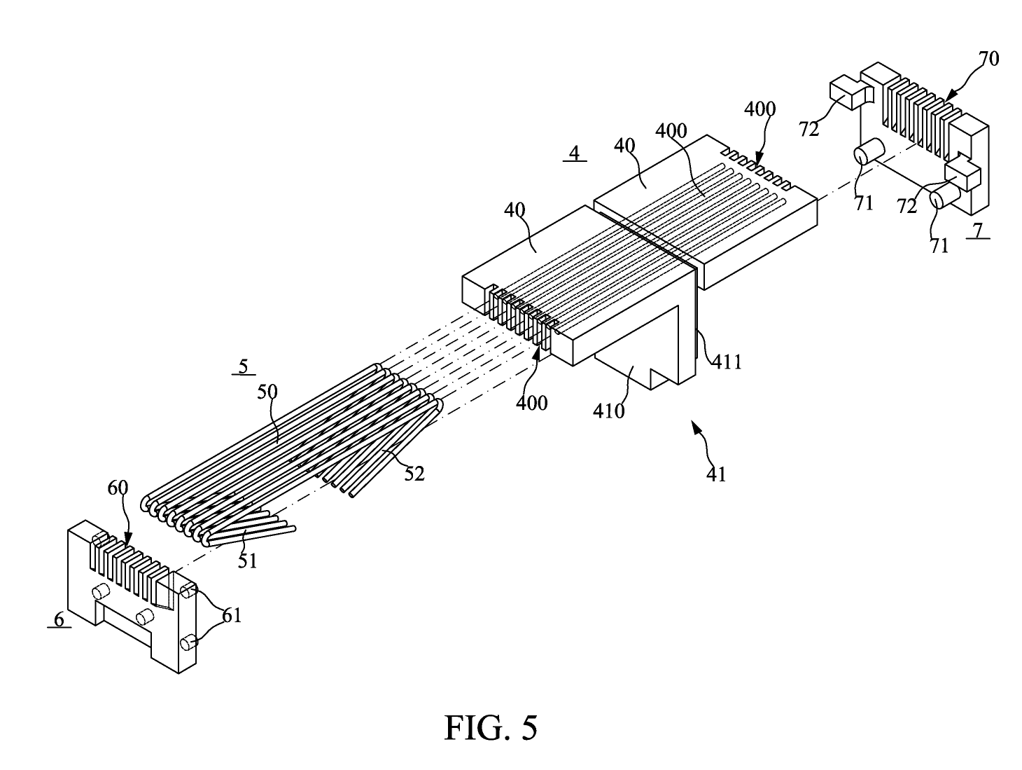

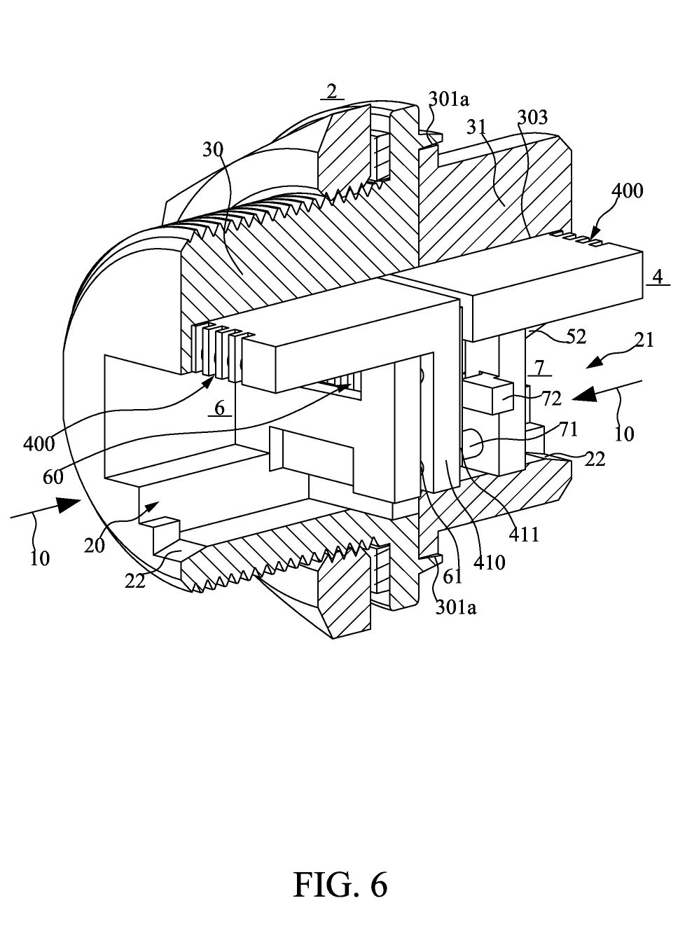

Please refer to FIGS. 1 to 6, in which an electrical connector for network cables according to a preferred embodiment of the present invention is shown. For the purpose of conciseness and clarity, the present invention is also briefly referred to as the electrical connector and generally denoted by numeral reference 1 herein. As shown, the electrical connector 1 includes a shell 2, a plurality of conducting elements 5, a first locating member 6 and a second locating member 7.

The shell 2 defines at least two cable insertion directions 10, along each of which a network cable (not shown) is inserted into the electrical connector 1. The two cable insertion directions 10 can be the same with or opposite to each other. In a preferred operable embodiment of the present invention, the shell 2 includes an outer shell portion 3 and an internal stopper 4. The outer shell portion 3 includes a front shell 30 and a rear shell 31. In the preferred operable embodiment of the present invention, the front shell 30 and the rear shell 31 can be made of the same material or different materials.

The front and the rear shell 30, 31 include a first tubular section 300 and a second tubular section 310, respectively. The first tubular section 300 and the rear tubular section 310 are correspondingly provided on their contact surfaces with at least one retaining slot 300a and at least one protruded block 310a, respectively. The retaining slot 300a is sunken from the contact surface of the first tubular section 300 in the cable insertion direction 10 defined by the first tubular section 300, and the protruded block 310a is projected from the contact surface of the second tubular section 310 in the cable insertion direction 10 defined by the second tubular section 310. Through engagement of the protruded block 310a with the retaining slot 300a, the front shell 30 and the rear shell 31 are prevented from rotating relative to each other.

The first tubular section 300 and the second tubular section 310 are formed at their facing ends with a first radially protruded annular section 301 and a second radially protruded annular section 311, respectively. On one side of the first radially protruded annular section 301 facing toward the second tubular section 310, there is formed an annular wall portion 301a, which is extended in the cable insertion direction 10 defined by the first tubular section 300 and has a first outer diameter 302. The second radially protruded annular section 311 has a second outer diameter 312.

The first tubular section 300 and the second tubular section 310 internally define a first insertion space 20 and a second insertion space 21, respectively. The first and the second insertion space 20, 21 defined in the first and the second tubular section 300, 310, respectively, are axially outward extended to form a through hole 32 between two opposite end surfaces of the outer shell portion 3. Network cables can be separately inserted into the first and the second insertion space 20, 21 via two open ends of the through hole 32 on the two end surfaces of the outer shell portion 3.

The first insertion space 20 and the second insertion space 21 can be parallelly located and oriented to the same direction (not shown) or be located serially and oriented to two opposite directions as shown in the illustrated drawings. When the annular wall portion 301a of the front shell 30 is riveted, the first outer diameter 302 of the annular wall portion 301a is reduced to tightly press against the second outer diameter 312 of the second radially protruded annular section 311. At this point, the front shell 30 and the rear shell 31 are firmly connected to each other end to end.

The internal stopper 4 is disposed in the through hole 32 defined in the shell 2, and includes a pressing portion 40 and a separating portion 41. The pressing portion 40 is extended parallel to and in contact with an inner wall surface of the through hole 32. The separating portion 41 separates the first insertion space 20 and the second insertion space 21 from each other to form two independent spaces. In a preferred operable embodiment of the present invention, the pressing portion 40 and the separating portion 41 are connected to each other to show a T-shaped configuration.

The pressing portion 40 is internally formed with a plurality of passages 400, which communicate the first insertion space 20 with the second insertion space 21. The passages 400 are parallelly arranged to space from one another. The separating portion 41 includes a first separating block 410 and a second separating block 411, which are in contact with while press against the first tubular section 300 and the second tubular section 310, respectively. According to a preferred operable embodiment of the present invention, in view that the first and the second tubular section 300, 310 have inner wall surfaces that define different inner diameters, the second separating block 411 is designed to have a width smaller than that of the first separating block 410. Accordingly, the first separating block 410 and the second separating block 411 can upward press against the pressing portion 40 of the internal stopper 4 while downward pressing against the inner wall surfaces of the first tubular section 300 and the second tubular section 310.

A part of an inner wall surface of the outer shell portion 3 that is in contact with the pressing portion 40 and the separating portion 41 is formed into a recess 303. In a preferred operable embodiment of the present invention, waterproof glue 304 is applied in the recess 303 to ensure a watertight sealing between the outer shell portion 3 and the internal stopper 4, so that moisture is prevented from entering into the outer shell portion 3 to achieve a rust-resistance effect.

The conducting elements 5 are mounted in the passages 400 and respectively include a conducting section 50 seated in the passage 400 and a first and a second contacting section 51, 52 extended from two opposite ends of the conducting section 50. The first contacting sections 51 of the conducting elements 5 are extended into the first insertion space 20, and the second contacting sections 52 of the conducting elements 5 are extended into the second insertion space 21.

The first locating member 6 is mounted in the first insertion space 20 and includes a plurality of first guide slots 60. The first guide slots 60 are correspondingly located below the passages 400 to respectively receive a partial length of one of the first contacting sections 51, such that the first contacting sections 51 being pushed are limited to only a vertical movement in the first guide slots 60. By “vertical movement”, it means the first contacting sections 51 being pushed are moved in a direction normal to the cable insertion direction 10.

The second locating member 7 is mounted in the second insertion space 21 and includes a plurality of second guide slots 70. The second guide slots 70 are correspondingly located below the passages 400 to respectively receive a partial length of each of the second contacting sections 52, such that the second contacting sections 52 being pushed are limited to only a vertical movement in the second guide slots 70. By “vertical movement”, it means the second contacting sections 52 being pushed are moved in a direction normal to the cable insertion direction 10.

When two network cables are fully inserted into the first insertion space 20 and the second insertion space 21, their front ends will contact with and press against the first contacting sections 51 and the second contacting sections 52, respectively. Being subjected to contact pressure, the first and the second contacting sections 51, 52 with the property of elastic energy release will move vertically in the first and the second guide slots 60, 70, respectively. At this point, the first and the second contacting sections 51, 52 are electrically connected to the front ends of the network cables while elastically pressing against one side of the network cables to firmly clamp the latter in the first and the second insertion space 20, 21, respectively.

The first locating member 6 is provided on a surface adjacent to the internal stopper 4 with at least one first pressing section 61, and the second locating member 7 is provided on a surface adjacent to the internal stopper 4 with at least one second pressing section 71 and at least one third pressing section 72. In a preferred operable embodiment of the present invention, the first pressing sections 61 and the second and third pressing sections 71, 72 are blocks of the same or different shapes projected from one surface of the first and the second locating member 6, 7, respectively. When the network cables are inserted into the first and the second insertion space 20, 21 with their front ends pressing against another surface of the first and the second locating member 6, 7 that face toward the open ends of the through hole 32, the first pressing sections 61 on the other surface of the first locating member 6 and the second and third pressing sections 71, 72 on the other surface of the second locating member 7 are brought to move toward and press against two opposite surfaces of the separating portion 41 of the internal stopper 4. Wherein, the third pressing sections 72 respectively have a part that helps to press against the separating portion 41 of the internal stopper 4 and is located corresponding to one of the protruded blocks 310a on the rear shell 31 and can therefore, together with the protruded block 310a, push against one corresponding retaining slot 300a on the first tubular section 300.

Further, the first and the second insertion space 20, 21 are provided at the open ends of the through hole 32 with a beveled surface 22 each. The beveled surfaces 22 facilitate smooth sliding of the network cables into the first and the second insertion space 20, 21. The network cables are respectively provided with an elastic pressing end, which will be abutted on positions of the shell 2 behind the beveled surfaces 22 when the network cables have been inserted into the first and the second insertion space 20, 21.

The present invention has been described with some preferred embodiments thereof and it is understood that many changes and modifications in the described embodiments can be carried out without departing from the scope and the spirit of the invention that is intended to be limited only by the appended claims.

1. An electrical connector for network cables, comprising:
a shell internally defining a first insertion space and a second insertion space, which are communicable with each other via a plurality of passages, and including
an outer shell portion internally defining a through hole having two open ends respectively formed on two opposite end surfaces of the outer shell portion; and
an internal stopper disposed in the through hole and including a pressing portion fitted and held in place in the through hole, and a separating portion separating the through hole into the first insertion space and the second insertion space, the passages being parallelly arranged in the pressing portion to be spaced from one another;
a plurality of conducting elements correspondingly mounted in the passages, each of the conducting elements including a conducting section seated in a respective one of the passages and a first and a second contacting section extended from two opposite ends of the conducting section, the first contacting sections being extended into the first insertion space, and the second contacting sections being extended into the second insertion space;
a first locating member mounted in the first insertion space and including a plurality of first guide slots, the first guide slots respectively receiving a partial length of one of the first contacting sections, such that the first contacting sections being pushed by front ends of respective network cables are limited to only a vertical movement in the first guide slots; and
a second locating member mounted in the second insertion space and including a plurality of second guide slots, the second guide slots respectively receiving a partial length of one of the second contacting sections, such that the second contacting sections being pushed by front ends of the respective network cables are limited to only a vertical movement in the second guide slots.

2. (canceled)

3. The electrical connector for network cables as claimed in claim 1, wherein the outer shell portion includes:
a front shell including a first tubular section and a first radially protruded annular section formed at an end of the first tubular section; the first radially protruded annular section being formed on one side with an annular wall portion, which is extended in a cable insertion direction; and the annular wall portion having a first outer diameter; and
a rear shell including a second tubular section and a second radially protruded annular section formed at an end of the second tubular section to face toward the first radially protruded annular section; and the second radially protruded annular section having a second outer diameter that is smaller than the first outer diameter; and
wherein when the annular wall portion of the front shell is riveted, the first outer diameter of the annular wall portion is reduced to tightly press against the second outer diameter of the second radially protruded annular section, bringing the front shell and the rear shell to firmly connect to each other end to end.

4. The electrical connector for network cables as claimed in claim 3, wherein the first tubular section and the second tubular section are correspondingly provided on their contact surfaces with at least one retaining slot and at least one protruded block, respectively; the retaining slot being sunken from the contact surface of the first tubular section in the cable insertion direction, and the protruded block being projected from the contact surface of the second tubular section in the cable insertion direction; whereby when the protruded blocks are engaged with the retaining slots, the front shell and the rear shell are prevented from rotating relative to each other.

5. The electrical connector for network cables as claimed in claim 3, wherein the front shell and the rear shell are made of different materials.

6. The electrical connector for network cables as claimed in claim 5, wherein a part of an inner wall surface of the outer shell portion that is in contact with the pressing portion and the separating portion of the internal stopper is formed into a recess, and a waterproof glue being applied in the recess to ensure a watertight and rust-resistant sealing between the outer shell portion and the internal stopper.

7. The electrical connector for network cables as claimed in claim 4, wherein the first locating member is provided on a surface adjacent to the internal stopper with at least one first pressing section, and the second locating member is provided on a surface adjacent to the internal stopper with at least one second pressing section and at least one third pressing section; and the at least one third pressing section being located corresponding to the at least one protruded block on the second tubular section of the rear shell and also pushing against the at least one retaining slot on the first tubular section of the front shell.
